(19) United States
(12) Patent Application Publication
(10) Pub. No.: US 2009/0229076 A1
(43) Pub. Date: Sep. 17, 2009

(54) ABSORPTION MECHANISM FOR FURNITURE DOORS

(76) Inventor: Horst Lautenschlager, Reinheim (DE)

Correspondence Address: WRB-IP LLP, 1217 KING STREET, ALEXANDRIA, VA, 22314, US

(21) Appl. No.: 12/186,700

(22) Filed: Aug. 6, 2008

(30) Foreign Application Priority Data
Mar. 13, 2008 (DE) 102008013986.6-31

(51) Int. Cl. E05F 5/10

(52) U.S. Cl. 16/84

(57) ABSTRACT

A damping device for furniture door leaves comprising a damping cylinder in a damping housing (8) with the housing being connected to a damping carrier (12). The damping carrier (12) accommodates the edge of the front frame (3) between an outside retaining leg L (13) [sic] and an inside clamping leg (14). The clamping leg (14) is clamped against the front frame (3) by way of a clamping device (16). The clamping device comprises an eccentric (16) that pivots on the damping carrier (12) and acts on the clamping leg (14) with the eccentric (16) being connected to a pivoting lever (18).

The invention relates to a damping device for furniture door leaves comprising a damping housing that accommodates a damping cylinder, with the housing being connected to a damping carrier that is fastened to a front frame of a piece of furniture.

Such damping devices dampen the closing motion of furniture door leaves to prevent sudden, forceful contact of the door leaf with the body of the piece of furniture or its front frame. It is known to connect door hinges of the door leaves with the damping devices. However, this design does not allow for retrofitting door hinges that initially do not have any damping devices. Furthermore, this design requires that all door hinges be equipped with damping devices regardless of whether or not damping devices are needed. If it is necessary to subsequently retrofit a door leaf with a damping device, the entire door hinge must be replaced.

To avoid these disadvantages, it is known to fasten the damping devices so that they can be removed from door hinges or so that the door hinges can be retrofitted with them. To this end, however, it is necessary to install the required fastening elements for a damping device to the door hinges (U.S. Pat. No. 6,591,454 B2). If door hinges are not designed in this manner for retrofitting purposes for a damping device, it is not possible to retrofit the hinge.

The object of the invention therefore is to provide a damping device as described in the introduction that can be attached independent of the door hinges that are used.

The object of the invention is attained according to the invention in that the damping carrier accommodates the edge of the front frame between an outside retaining leg and an inside clamping leg and in that the clamping leg is clamped against the front frame by way of a clamping device.

The resulting clamping connection between the damping carrier of the damping device and the front frame of the furniture piece makes it possible to easily install the damping device either during the initial assembly of the furniture piece or as part of a retrofit without requiring any bores or screws.

Clamp fitting the damping carrier to the front frame of the furniture piece results in a stable connection that is suitable for transferring even high damping forces. The damping device can be removed from the furniture piece again without leaving any screw holes or other damage.

The damping device can easily be retrofitted to furniture pieces with any kind of door hinge. It also is possible to subsequently remove or move damping devices.

The simple fastening manner of this damping device also allows for an adjustment to different damping requirements of a furniture piece. For example, it is possible to use multiple damping devices for large and heavy furniture door leaves, while a single damping device suffices for light and small furniture door leaves. For cost saving reasons or for adjusting to different uses, it is possible to remove the originally installed damping devices from individual furniture door leaves, or to not install them at all.

According to one embodiment of the inventive thought the clamping device has an eccentric that is fastened in a pivoting manner to the damping carrier and that acts on the clamping leg. This eccentric provides a clamping device with a simple design that is easy to operate and that only requires that the clamping leg be ductile, preferably elastic.

The eccentric can be connected to a pivoting lever that allows for an easy horizontal sweep of the eccentric.

It also is possible to make the damping housing pivot relative to the damping carrier and to connect it in a rigid manner to the eccentric by means of a connecting piece. In this case the pivoting damping housing forms the actuating lever of the eccentric. The pivoting motion of the damping housing up to its end position on the damping carrier operates the clamp fitting of the damping device on the front frame of the furniture piece.

No tools are required for fastening or removing the damping device.

Additional advantageous embodiments of the inventive thought are the subject of additional sub-claims.

The invention is explained in more detail based on exemplary embodiments that are shown in the drawing. The following is shown.

FIG. 1 shows a cross-section of a damping device that is placed on but not yet clamped onto a furniture piece,

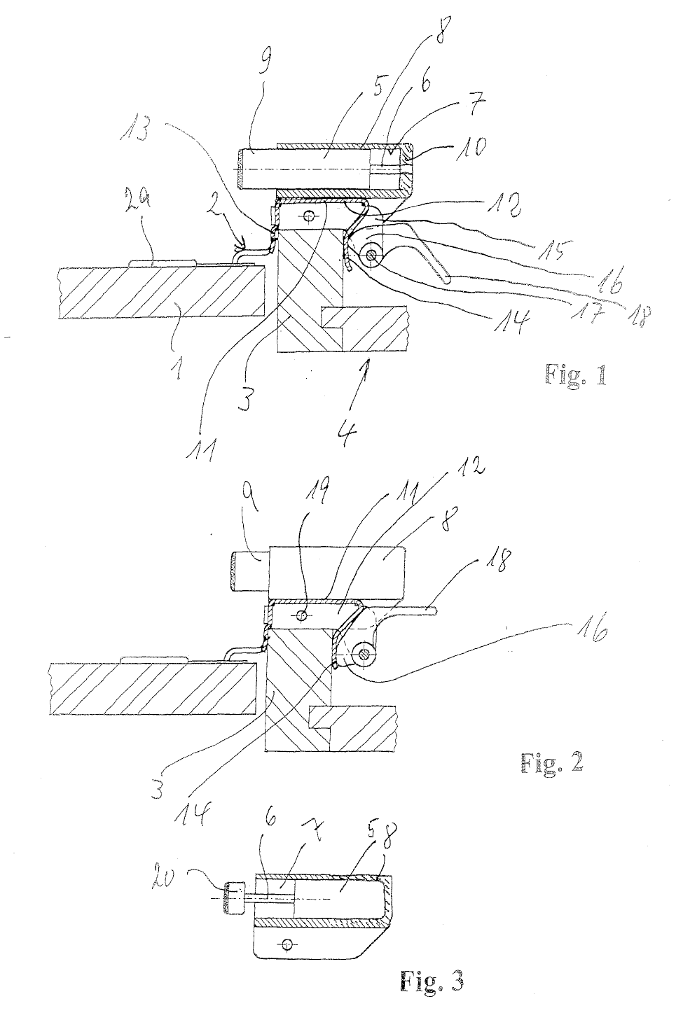

FIG. 2 shows the damping device according to FIG. 1 after it is clamped on,

FIG. 3 shows a cross-section of a modified arrangement of the damping cylinder in the damping housing,

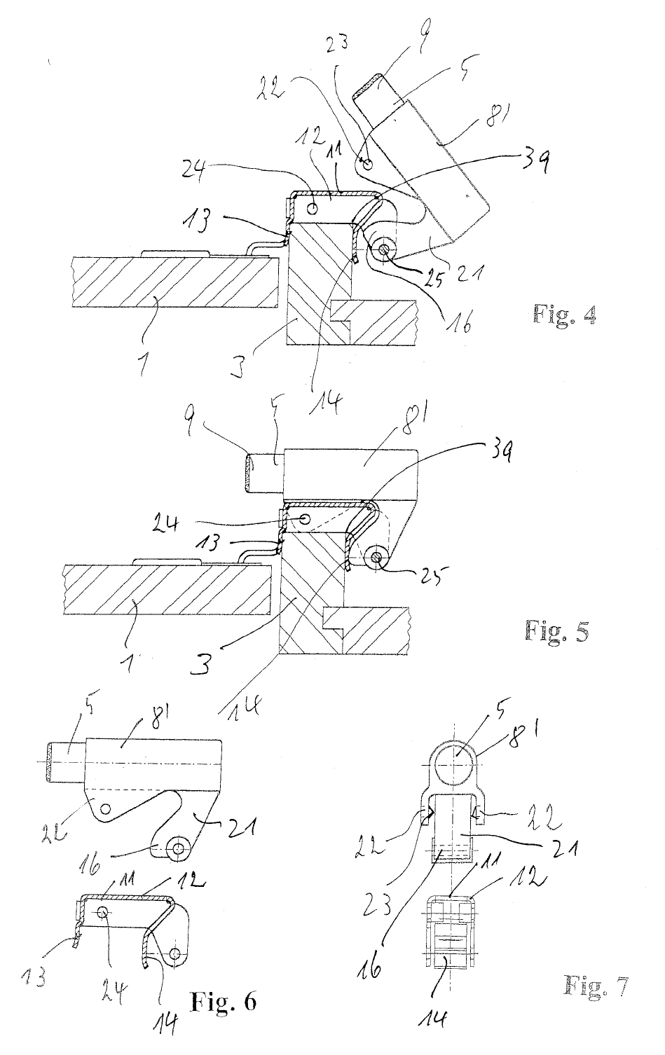

FIG. 4 shows a presentation according to FIG. 1 of a modified embodiment of a damping device with a pivoting damping housing that is not yet clamped,

FIG. 5 shows the damping device according to FIG. 4 in the clamped position on the front frame, FIG. 6 shows an extended presentation and a partial cross-section of the damping carrier and the damping housing of the damping device according to FIG. 4 and FIG. 5 from a lateral view,

FIG. 7 shows a front view of the parts according to FIG. 6,

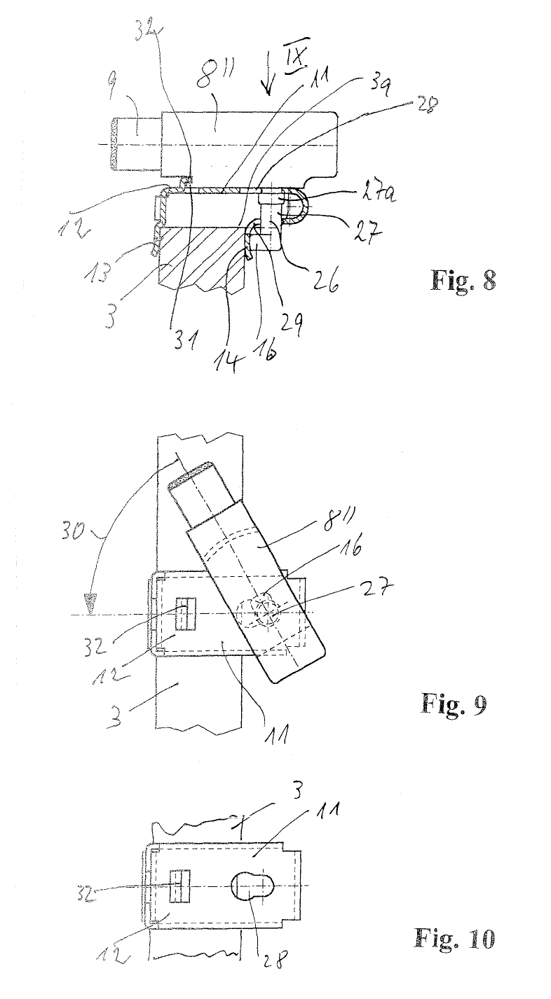

FIG. 8 shows a modified embodiment of a damping device in a presentation that corresponds to FIG. 1,

FIG. 9 shows a top view in the direction of arrow IX in FIG. 8 in a position prior to clamping the damping device to the front frame,

FIG. 10 shows a top view according to FIG. 9 onto the damping carrier prior to inserting the damping cylinder, and

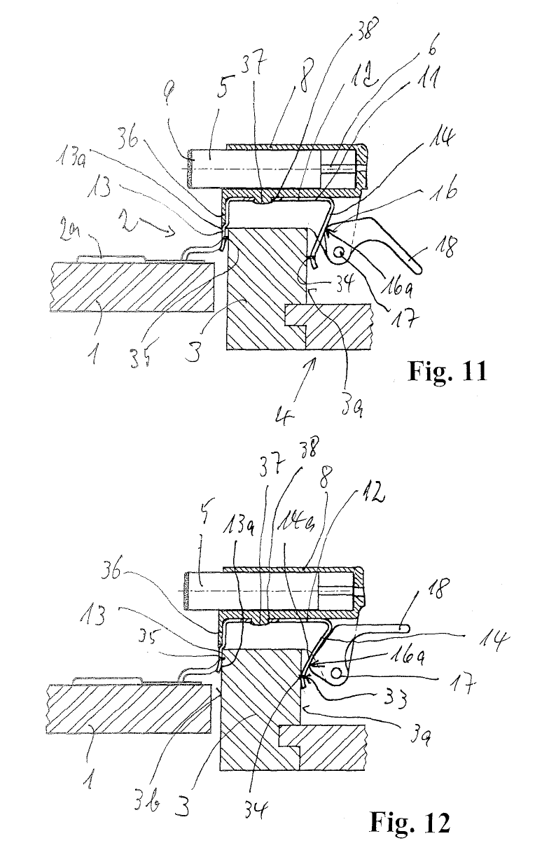

FIG. 11 and FIG. 12 show the cross-section of another modified embodiment of a damping device.

The damping device shown in FIGS. 1 and 2 is used to dampen the closing motion of a door leaf 1 that is arranged in a pivoting manner to a front frame 3 of a furniture piece 4 by way of a door hinge 2.

A damping cylinder 5, comprising a damping piston and a piston rod 6, is inserted into a location hole 7 of a damping housing 8 so it can be longitudinally displaced. The cylinder end 9 that extends from the location hole 7 on the side of the door constitutes a stop for the door leaf 1.

Shortly before the end of its closing motion, the door leaf 1 preferably meets the cylinder end 9 that extends from the location hole 7 with a metal piece 2a of the furniture hinge that preferably is fastened to the door leaf 1 and moves the damping cylinder 5 towards the end of the location hole 7 that is closed towards the front, with the damping cylinder 5 resting on a face wall 10 of the damping housing 8 by way of its piston rod 6. In doing so the damping force, which is determined by speed, counteracts the closing motion of the door leaf 1.

The damping housing 8 is fastened to a bridge plate 11 of a damping carrier 12 that can be made of tin, for example. The damping carrier 12 comprises a retaining leg 13 that rests on the outside of the front frame 3 and a clamping leg 14 that rests on the inside of the front frame 7.

An eccentric 16 is arranged in a pivoting manner in a pivoting axis 17 between lateral cheeks 15 of the damping carrier 12. The eccentric 16 is connected in a single piece with a pivoting lever 18 that extends into the inside of the body of a piece of furniture.

When the eccentric 16 is pivoted counterclockwise in FIG. 1 into the clamping position shown in FIG. 2 using the pivoting lever 18, the eccentric 16 pushes the elastic clamping leg 14 against the inside of the front frame 3 so that the damping carrier 11 rest against the front frame 3 together with the damping housing 8 that is fastened to the carrier by means of a connecting pin 19, for example.

If the damping device is to be loosened, for example removed or moved, from the front frame 3, it is sufficient to loosen the eccentric 16 using a pivoting motion of the pivoting lever 18 in clockwise direction. The edge of the front frame 3 is released in the damping carrier 12 in the process.

Deviating from the longitudinal arrangement of the damping cylinder 5 in the location hole 7 shown in FIG. 1, FIG. 3 shows that the damping cylinder 5 is fastened at the end of the bore in the location hole 7 of the damping housing 8. The piston rod head 20 of the piston rod 6 extends from the location hole 7 and provides the stop for the door leaf 1.

The embodiment shown in FIGS. 4-7 is different from the embodiment according to FIGS. 1-3 in that the damping housing 8′ pivots relative to the damping carrier 12. The damping housing 8′ is connected to the eccentric 16 in a rigid manner by way of a connecting piece 21.

In this embodiment the damping housing 8′ that is connected in a rigid manner with the eccentric 16 represents the pivoting lever, with which the eccentric 16 is pivoted from its released position shown in FIG. 4 into the clamping position according to FIG. 5.

The damping housing 8′ has a latching device 23 each on two lateral brackets 22 that latch into the clamping position (FIG. 5) on lateral bores 24 of the damping carrier 12.

In the exemplary embodiment according to FIGS. 4 and 5 the damping housing 8′ is arranged in a pivoting manner around a pivoting axis 25 on the damping carrier 12 that extends parallel to the edge 3a of the front frame 3 that accommodates the damping carrier 12. The pivoting axis 25 thus also runs parallel to the pivoting axis of the door leaf 1.

The exemplary embodiment according to FIGS. 8-10 substantially is different from this, in that the pivoting axis 26, around which the damping housing 8″ on the damping carrier 12 pivots, extends parallel to the plane of the front frame 3 and at a right angle to the edge 3a of the front frame 3 that accommodates the damping carrier 12.

The damping housing 8″ is connected in a rigid manner to the eccentric 16 by way of a pivoting shaft 27, which in turn is arranged in a rotating manner in the damping carrier 12.

To this end the pivoting shaft 27 extends through an upper opening 28 and a lower opening 29 of the damping carrier 12. The upper opening 28 is shaped like a keyhole. The pivoting shaft 27 has a collar 27a that can be inserted through the wider section of the opening 28 and engages the edge of the narrower section of the opening 28 when mounted (FIG. 8).

The damping housing 8″ can be pivoted into the retaining position according to FIG. 8 with a pivoting motion that is indicated with an arrow 30 in FIG. 9, in which a retaining projection 31 on the bottom side of the damping housing 8″ engages with a retaining edge 32 on the upper side of the damping carrier 12.

This keeps the damping housing 8′ in its retaining position according to FIG. 8, while the section of the pivoting axis 27 arranged between the collar 27a and the damping housing 8″ is housed in a rotating manner in the narrower section of the opening 28 (right side in FIGS. 8-10). Simultaneously the engagement between the retaining projection 31 and the retaining edge 32 prevents the damping housing 8″ from lifting from the damping carrier 12.

In the embodiment according to FIGS. 8-10 the eccentric 16, similar to the embodiment according to FIGS. 4 and 5, pushes onto the clamping leg 14, so that the frame 3 is clamped between the retaining leg 13 and the clamping leg 14. To release the damping device, it suffices to turn in counter direction of arrow 30 in FIG. 9. The eccentric 16 releases the clamping leg 14, so that the damping retainer [sic] 12 can be removed from the front frame 3.

The embodiment of a damping device shown in FIGS. 11 and 12 represents a cross section that corresponds to FIG. 1 and primarily is different from the exemplary embodiment according to FIG. 1 in that the engagement area 16a of the eccentric 16 is on the elastic clamping leg 14 in the clamped state (FIG. 12) at a distance from the contact point 33 of the clamping leg 14 with the front frame 3. The result is that an elastic section of the overall elastic clamping leg 14 remains between the engagement area 16a and the contact point 33 while in the clamped state (FIG. 12). The resulting elastic contact of the clamping leg 14 on the back 3a of the front frame 3 causes a compensation of thickness tolerances of the front frame 3.

The clamping leg 14 and/or the retaining leg 13 comprises at least one protruding retaining tooth 34 or 35 on the inside surface 14a or 13a, respectively, that faces the front frame 3 that penetrates the back side 3a or the front side 3b of the front frame 3, when in the clamped state (FIG. 12) and thus provides a positive connection between the damping carrier 12 and the front frame 3 in addition to the clamping.

The damping housing 8 is connected in a rigid manner with a bent support bracket 36, for example as a single piece, that partially rests against the outside 13a of the retaining leg 13. This results in the retaining leg 13, which preferably is made as a single piece from the same elastic tin material as the clamping leg 14, not being substantially deformed due to the forces during the damping process.

FIGS. 11 and 12 show that the damping housing 8 comprises a connecting pin 37 that extends from the bottom side of the damping housing 8 that faces the damping carrier 12 and is fastened in a bore 38 of the damping carrier by way of wobble riveting. This provides a secure connection which is favorable for production between the damping housing 8 and the damping carrier 12.

1. Damping device for furniture door leaves comprising a damping housing that accommodates a damping cylinder, with the housing being connected to a damping carrier that is fastened to a front frame of a furniture piece, wherein the damping carrier accommodates the edge of the front frame between an outside retaining leg and an inside clamping leg and the clamping leg is clamped against the front frame by way of a clamping device.

2. Damping device according to claim 1, wherein the clamping device comprises an eccentric that pivots on the damping carrier and acts on the clamping leg.

3. Damping device according to claim 2, wherein the eccentric is connected to a pivoting lever.

4. Damping device according to claim 2, wherein the damping housing pivots relative to the damping carrier and is connected to the eccentric in a rigid manner by way of a connecting piece.

5. Damping device according to claim 4, wherein the damping housing latches into the clamping position of the eccentric on the damping carrier by way of a latching device.

6. Damping device according to claim 4, wherein the damping housing together with the eccentric is arranged in a pivoting manner around a pivoting axis that extends parallel to the edge of the front frame that accommodates the damping carrier.

7. Damping device according to claim 4, wherein the damping housing together with the eccentric is arranged in a pivoting manner around a pivoting axis that extends parallel to the plane of the front frame and at a right angle to the edge of the front frame that accommodates the damping carrier.

8. Damping device according to claim 7, wherein the damping housing is connected in a rigid manner to the eccentric by way of a pivoting shaft, which is arranged in a rotating manner in the damping carrier.

9. Damping device according to claim 7, wherein the damping housing can be pivoted into a retaining position with a pivoting motion, in which a retaining projection of the damping housing engages with a retaining edge of the damping carrier.

10. Damping device according to claim 1, wherein the damping cylinder extends from the damping housing and can be moved in longitudinal direction in the damping housing and its piston rod rests against the damping housing.

11. Damping device according to claim 1, wherein the damping cylinder is arranged in the damping housing and its piston rod extends from the damping housing.

12. Damping device according to claim 2, wherein the clamping leg is elastic and the engagement area of the eccentric is in the clamped state at a distance from the contact point of the clamping leg with the front frame.

13. Damping device according to claim 1, wherein the clamping leg and/or the retaining leg comprises at least one protruding retaining tooth on the inside surface that faces the front frame.

14. Damping device according to claim , wherein the damping housing is connected in a rigid manner with a support bracket that rests at least partially against the outside of the retaining leg.

15. Damping device according to claim 1, wherein the damping housing comprises a connecting pin that is fastened in a bore of the damping carrier by way of wobble riveting.
